(19) United States
(12) Patent Application Publication
(10) Pub. No.: US 2007/0119936 A1
(43) Pub. Date: May 31, 2007

(54) Barcode reader

(75) Inventors: Masanori Ohkawa, Inagi (JP); Mitsuharu Ishii, Inagi (JP); Mitsuo Watanabe, Inagi (JP); Masakazu Yokota, Inagi (JP); Shunji Shimada, Inagi (JP); Taku Ando, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki (JP); FUJITSU FRONTECH LIMITED, Inagi-shi (JP)

(21) Appl. No.: 11/368,463

(22) Filed: Mar. 7, 2006

(30) Foreign Application Priority Data
Nov. 30, 2005 (JP) 2005-345882

(51) Int. Cl. G06K 7/10

(52) U.S. Cl. 235/462.01

(57) ABSTRACT

A barcode reader outputs a beep sound upon successfully reading a barcode. The barcode reader includes separate buttons for changing an output volume level and output tine level of the beep sound. The buttons are provided on a surface of the barcode reader.

### BACKGROUND OF THE INVENTION

1. Field of the Invention

The present invention generally relates to a barcode reader, and particularly relates to a barcode reader that outputs some sort of sound upon successfully reading a barcode.

2. Description of the Related Art

Barcodes are used to manage sales or stock of commodities. Barcode readers are used to read barcodes attached to the commodities. Some barcode readers make some sort of notifying sound (hereinafter, “confirmation beep”) upon successfully reading a barcode. If the operator of the barcode reader hears a confirmation beep, he/she decides that the barcode is read successfully, otherwise causes the barcode reader to again read the barcode.

The environments in which barcode readers are used can vary greatly. Some of the shops in which the barcode readers are used are small and others are big, some are quiet and others are noisy, some have only one barcode reader and others have a row of barcode readers. If a shop is small and quiet, an operator may clearly hear a confirmation beep of a barcode reader. However, if a shop is big and noisy, an operator may not clearly hear a confirmation beep of a barcode reader, and may unnecessarily perform reading operation again thereby reducing efficiency. Therefore, volume and tone of confirmation beeps made by barcode readers is important factor that determines efficiency.

Japanese Patent Laid-open Publication No. 2000-346700 discloses a barcode reader in which it is possible to adjust both volume and tone of confirmation beeps using one button. Japanese Patent Laid-open Publication No. 2002-352184 discloses a barcode reader in which it is possible to adjust volume and tone of confirmation beeps using separate buttons.

However, volume or tone control of confirmation beeps in the conventional barcode readers is not easy. Therefore, there is a need of a barcode reader in which it is possible to easily perform volume or tone control of confirmation beeps.

### SUMMARY OF THE INVENTION

It is an object of the present invention to at least solve the problems in the conventional technology.

According to an aspect of the present invention, a barcode reader that outputs a notifying sound upon successfully reading a barcode, includes a volume changing unit operable by a user to change a volume value indicative of an output volume level of the notifying sound; a volume setting changing unit that changes an output volume level of the notifying sound based on the volume value; a tone changing unit operable by the user to change a tone value indicative of an output tone level of the notifying sound; a tone setting changing unit that changes an output tone level of the notifying sound based on the tone value; and a beeping unit that outputs notifying sound at the volume level and the tone level.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of external appearance and configuration of a barcode reader according to a first embodiment of the present invention;

FIG. 2 is a block diagram of the barcode reader shown in FIG. 1;

FIG. 3 is a schematic for explaining a correspondence between confirmation beep setting and confirmation beep setting lists according to the first embodiment;

FIG. 4 is a flowchart of a barcode reading process by the barcode reader shown in FIG. 1;

FIG. 5A is a flowchart of a beep setting change process according to the first embodiment;

FIG. 5B is a continuation of the flowchart shown in FIG. 5A;

FIG. 6 is schematic for explaining a correspondence between confirmation beep settings and confirmation beep setting lists according to a variant of the first embodiment;

FIG. 7 is schematic for explaining a correspondence between confirmation beep settings and confirmation beep setting lists according to a second embodiment of the present invention;

FIG. 8A is a flowchart of a confirmation beep setting change process according to the second embodiment; and

FIG. 8B is a continuation of the flowchart shown in FIG. 8A.

### DETAILED DESCRIPTION OF THE PREFERRED EMBODIMENTS

Exemplary embodiments of a barcode reader according to the present invention are explained in detail below with reference to the accompanying drawings. It is to be noted that the present invention is not limited to these embodiments.

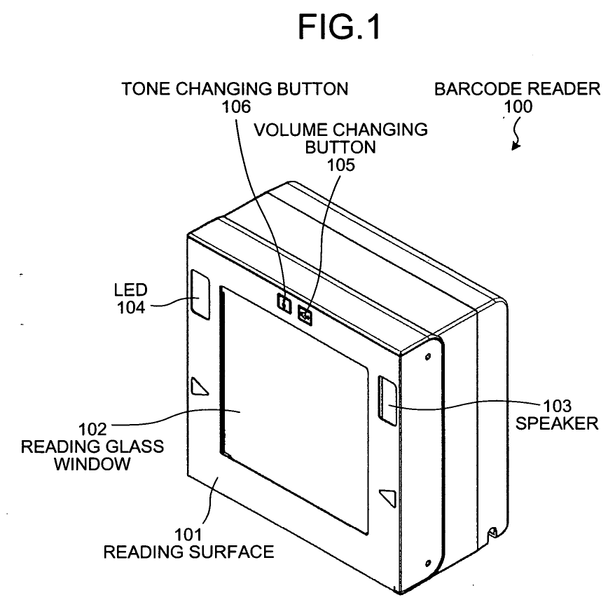

FIG. 1 is a perspective view of external appearance and configuration of a barcode reader 100 according to a first embodiment of the present invention. The barcode reader 100 includes a reading surface 101. The reading surface 101 includes a reading glass window 102. Light is irradiated through the reading glass window 102 on a barcode attached on a commodity and light reflected from the barcode is taken in also through the reading glass window 102 to thereby optically read the barcode. The barcode reader 100 includes a speaker 103 as a beeping unit, and a yellow light emitting diode (LED) 104. When the barcode reader successfully reads a barcode, the speaker 103 outputs a confirmation beep and the light emitting diode (LED) 104 is lit so that an operator of the barcode reader comes to know that the barcode is successfully read.

The barcode reader 100 includes a volume changing button 105. Volume of a confirmation beep can be changed by pressing down the volume changing button 105. The volume of a confirmation beep can be changed in eight levels. Every time when the volume changing button 105 is pressed down, output volume is changed by one level.

The barcode reader 100 includes a tone changing button 106. Tone of a confirmation beep can be changed by pressing down the changing button 106. The tone of a confirmation beep can be changed in eight levels. Every time when the tone changing button 106 is pressed down, frequency of the confirmation beep is changed by a predetermined value.

On each surface of the volume changing button 105 and the tone changing button 106, a symbolic figure expressing the function of each button is printed. A figure imitating a speaker in a horn shape is printed on the surface of the volume changing button 105, and a G treble clef is printed on the tone changing button 106.

Thus, volume of a confirmation beep can be changed with the volume changing button 105 and tone can be changed with the tone changing button 106 only by pressing down the respective button.

The volume changing button 105 and the tone changing button 106 are both provided on the same side as the reading surface 101. Thus, an operator can change a setting of volume and/or a tone of a confirmation beep easily without disturbing a checkout operation even during the checkout operation.

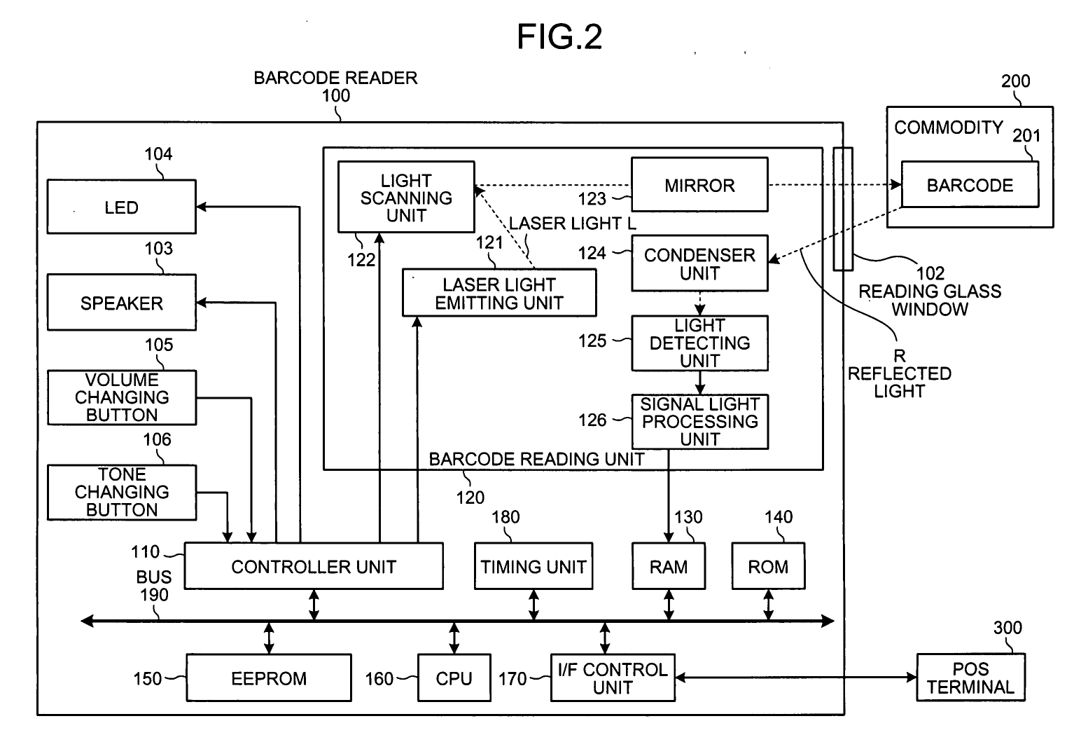

FIG. 2 is a block diagram of the barcode reader 100. The barcode reader 100 includes the speaker 103, the LED 104, the volume changing button 105, the tone changing button 106, a controller unit 110, a barcode reading unit 120, a random access memory (RAM) 130, a read-only memory (ROM) 140, a electronically erasable and programmable read only memory (EEPROM) 150, a central processing unit (CPU) 160, a I/F control unit 170, a timing unit 180, and a bus 190.

The controller unit 110 controls the speaker 103, the LED 104, and a laser light emitting unit 121 and a light scanning unit 122 owned by the barcode reading unit 120. When a barcode is successfully read, the controller unit 110 causes the speaker 103 to output a confirmation beep based on confirmation beep settings stored in the EEPROM 150, and lit the LED 104.

Furthermore, the controller unit 110 receives operations from the volume changing button 105 and the tone changing button 106, and when the volume changing button 105 is pressed down, the CPU 160 executes processing related to a setting change in volume of a confirmation beep, while the tone changing button 106 is pressed down, the CPU 160 executes processing related to a setting change in a tone of a confirmation beep.

The barcode reading unit 120 optically reads a barcode 201 attached on a commodity 200, and includes the laser light emitting unit 121, the light scanning unit 122, a mirror 123, a condenser unit 124, a light detecting unit 125, and a signal light processing unit 126.

The laser light emitting unit 121 emits a laser light L. The light scanning unit 122 is a rotating member such as a polygon mirror with a plurality of flat reflection surface. The light scanning unit 122 is rotated with a motor, to let the laser light L scan by reflecting the laser light L from the laser light emitting unit 121 with the rotating light scanning unit 122. The mirror 123 is a stationary reflective member, a plurality of which is arranged inside the barcode reader 100, and a scanning laser light L from the light scanning unit 122 is reflected on the mirror 123 and emitted towards the reading glass window 102.

The condenser unit 124 is a reflective member forming a concave, and condenses a reflection R made from scanning laser light L diffused on a barcode 201. The light detecting unit 125 detects intensity of condensed reflection R with the condenser unit 124. The signal light processing unit 126 processes the light intensity of the reflection R detected by the light detecting unit 125 into binary data to produce barcode data corresponding to the barcode 201.

This barcode data producing process by the barcode reading unit 120 is carried out in the following procedure. A laser light L emitted from the laser light emitting unit 121 is let scan by the rotating light scanning unit 122, emitted via the mirror 123 and the reading glass window 102 to outside the barcode reader 100, and radiated over a barcode 201 attached on a commodity 200.

The laser light L radiated over the barcode 201 diffuses, and part of it returns back as a reflection R to inside the barcode reader 100 again via the reading glass window 102. The reflection R is condensed by the condenser unit 124, and the light detecting unit 125 detects intensity of condensed reflection R. Based on a detected result by the light detecting unit 125, the signal light processing unit 126 produces barcode data corresponding to the barcode 201. Thus, produced barcode data is stored in the RAM 130.

The RAM 130 is a volatile memory to store barcode data produced by the signal light processing unit 126 in the barcode reading unit 120. The ROM 140 is a memory with stored various programs for only reading for the CPU 160 to execute in order to operate the barcode reader 100.

A procedure that the CPU 160 reads out each program from the ROM 140 and executes the program is described below in a simplified expression such that “the CPU 160 executes”.

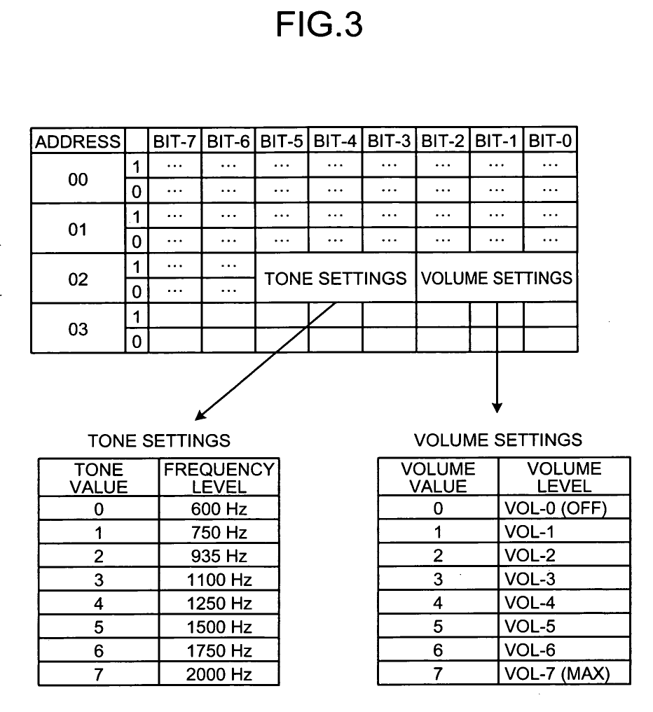

The EEPROM 150 is a nonvolatile memory, which is electrically erasable and rewritable, and stores confirmation beep settings for setting volume and/or a tone of a confirmation beep emitted from the speaker 103, and the like. FIG. 3 is a schematic for explaining a correspondence between confirmation beep settings and confirmation beep setting lists according to the first embodiment.

Top table in FIG. 3 depicts a format of confirmation beep settings stored in the EEPROM 150. As shown in the top table, in storage areas in the EEPROM 150, six bits are allocated to settings of a confirmation beep, and lower three bits among them relate to volume settings, and upper three bits relate to tone settings.

Bottom table in FIG. 3 depicts confirmation beep setting lists held in the controller unit 110. As shown in the bottom table, the controller unit 110 holds eight output volume levels corresponding to eight volume values and eight output frequency levels corresponding to eight tone values.

To make the speaker 103 emit a confirmation beep, the CPU 160 then reads out confirmation beep settings stored in the EEPROM 150, and transfers the read value to the controller unit 110. The controller unit 110 then translates that value into output volume level or output tone level, makes the speaker 103 emit a confirmation beep corresponding to the output volume level and output frequency level.

The controller unit 110 keeps eight output volume levels from Vol-0 to Vol-7. Vol-0 indicates volume OFF and Vol-7 indicates the maximum volume. Volume value 0 corresponds to volume level Vol-0 that indicates volume OFF, volume value 1 corresponds to volume level Vol-1 that is louder than Vol-0, and volume value 2 corresponds to volume level Vol-2 that is louder than Vol-1. Subsequently in a similar manner, as the volume value increases, corresponding volume level becomes louder. The maximum volume value 7 corresponds to the maximum volume level Vol-7.

When the volume changing button 105 is pressed down, the CPU 160 replaces a volume level in the confirmation beep settings stored in the EEPROM 150. In this operation, the volume value changes in order of 0, 1, 2, 3, . . . , 7 as the volume changing button 105 is pressed down each time, to step up output volume. If the volume changing button 105 is pressed down when the volume value is 7, the volume value is reset to 0.

When the volume changing button 105 is pressed down and volume setting is changed, the CPU 160 makes the speaker 103 emit a beep sound at changed volume via the controller unit 110 at once. This allows an operator to confirm the changed volume at once.

The controller unit 110 keeps eight output frequencies, where tone value 0 corresponds to the minimum frequency level 600 Hz, tone value 1 corresponds to frequency level 750 Hz, and tone value 2 corresponds to frequency level 935 Hz. Subsequently in a similar manner, as the tone value increases, a corresponding frequency level becomes higher, and the maximum tone value 7 corresponds to the highest frequency level 2000 Hz.

When the tone changing button 106 is pressed down, the CPU 160 replaces a tone value in the confirmation beep settings stored in the EEPROM 150. In this operation, the tone value changes in order of 0, 1, 2, 3, . . . , 7 as the tone changing button 106 is pressed down each time, to step up an output frequency. If the tone changing button 106 is pressed down when the tone value is 7, the tone value is reset to 0.

Furthermore, when the tone changing button 106 is pressed down, and a tone setting is changed, the CPU 160 makes the speaker 103 emit a beep sound with a changed tone via the controller unit 110 at once. This allows an operator to confirm the changed tone at once.

In addition, because volume values and tone values are stored in different storage areas in the EEPROM 150, the values can be changed separately. This allows an operator to change a volume setting and atone setting separately, thereby improving convenience.

The CPU 160 is a central processing unit that controls each unit in the barcode reader 100. The CPU 160 reads out computer programs stored in the ROM 140 and executes, for example, confirmation beep setting change process, in which settings of a confirmation beep to be emitted from the speaker 103 are changed.

The I/F control unit 170 transmits and receives data to and from a POS terminal 300 connected to the barcode reader 100, and transfers barcode data produced by the barcode reading unit 120 to the POS terminal 300.

The timing unit 180 counts time for which one or both of the volume changing button 105 and the tone changing button 106 are continuously pressed down. When the CPU 160 starts to detect a pressed down motion of the volume changing button 105 and/or the tone changing button 106 via the controller unit 110, the timing unit 180 starts to time the motion of the button(s), and when a release of the button(s) is detected, measured time is cleared. The bus 190 connects between the controller unit 110, the RAM 130, the ROM 140, the EEPROM 150, the CPU 160, the I/F control unit 170, and the timing unit 180.

A POS terminal 300 executes processing, such as checkout of commodities. A POS terminal 300 is connected to a host machine (not shown), and the host machine collects information from a plurality of POS terminals located inside a store to manage commodity inventory controls and the likes.

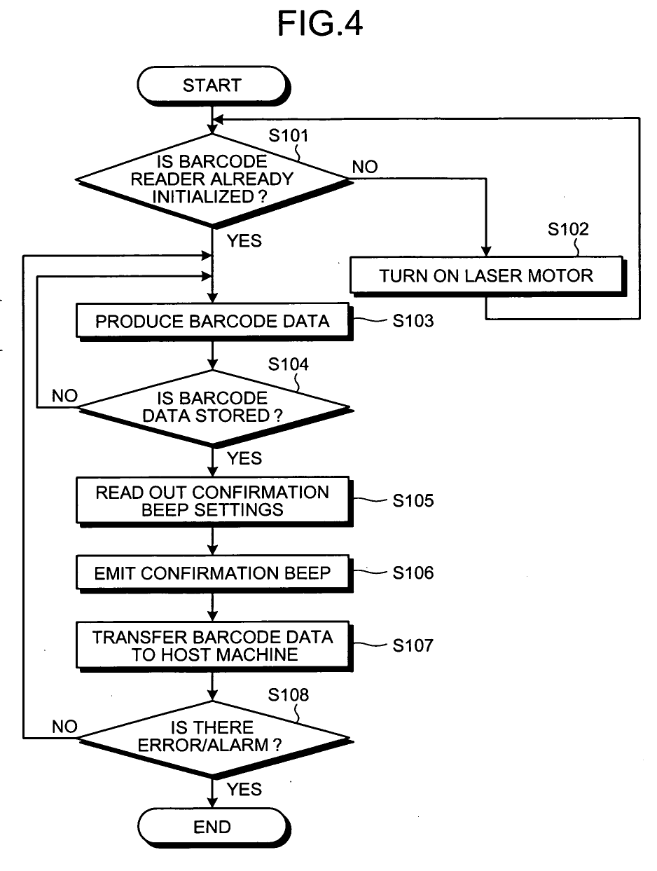

Next, a barcode reading process performed by the barcode reader 100 is explained. FIG. 4 is a flowchart of the barcode reading process. To begin, in the barcode reader 100, the CPU 160 in the barcode reader 100 determines whether the barcode reader 100 is already initialized (step S101). Specifically, the laser light emitting unit 121 and the light scanning unit 122 provided in the barcode reading unit 120 determine whether a barcode is ready to read a barcode.

If the barcode reader 100 is not initialized yet, the controller unit 110 starts emission of a laser light from the laser light emitting unit 121 and to drive a rotating motor equipped in the light scanning unit 122 (step S102), and then the processing control is returned to step S101.

By contrast, when the barcode reader 100 is already initialized, the barcode reading unit 120 carries out a barcode data producing process, in which the barcode reading unit 120 produces barcode data corresponding to a barcode 201 attached on the commodity 200, and stores the barcode data in the RAM 130 (step S103).

The CPU 160 then determines whether barcode data is stored in the RAM 130 (step S104), and, when barcode data is not stored, then the processing control is returned to step S103 to repeat the same process until barcode data is produced by the barcode reading unit 120.

When barcode data is successfully produced by the barcode reading unit 120 and the barcode data is stored in the RAM 130, the CPU 160 then reads out a confirmation beep settings stored in the EEPROM 150 (step S105), transfers the confirmation beep settings to the controller unit 110, and makes the speaker 103 emit a confirmation beep at a volume level and a tone level corresponding to the confirmation beep settings, and changes a lighting color of the LED 104 from green to yellow (step S106).

The CPU 160 then directs the I/F control unit 170 to transmit barcode data stored in the RAM 130 to a POS terminal 300, so that the barcode data is transferred via the POS terminal 300 to a host terminal (not shown) (step S107).

Subsequently, the CPU 160 determines whether information about error detection and/or alarm notice is received from each unit in the barcode reader 100 (step S108); and when there is neither error detection nor alarm notice, operation goes back to step S103; otherwise when information about error detection and/or alarm notice is received, the barcode reading process is terminated.

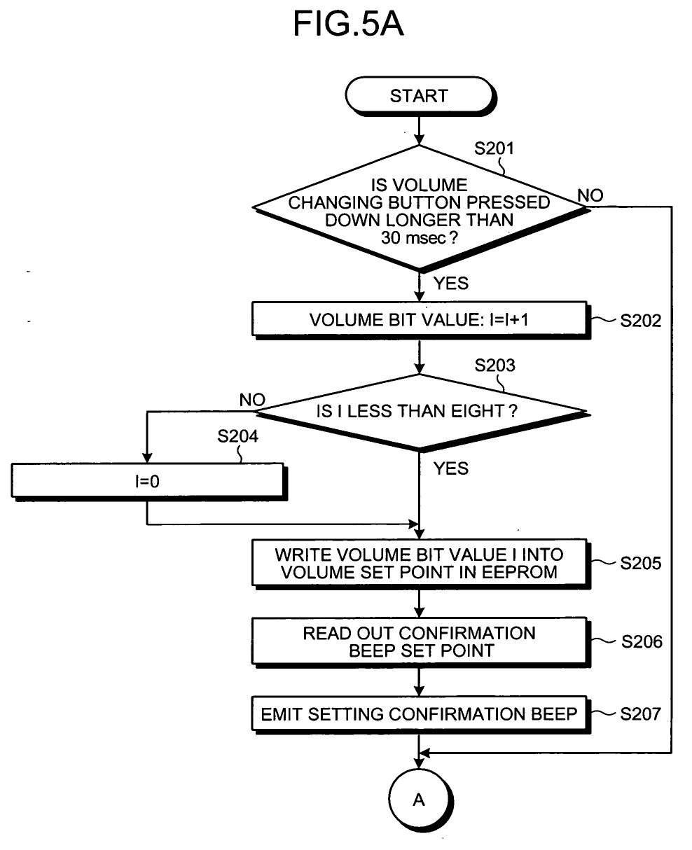

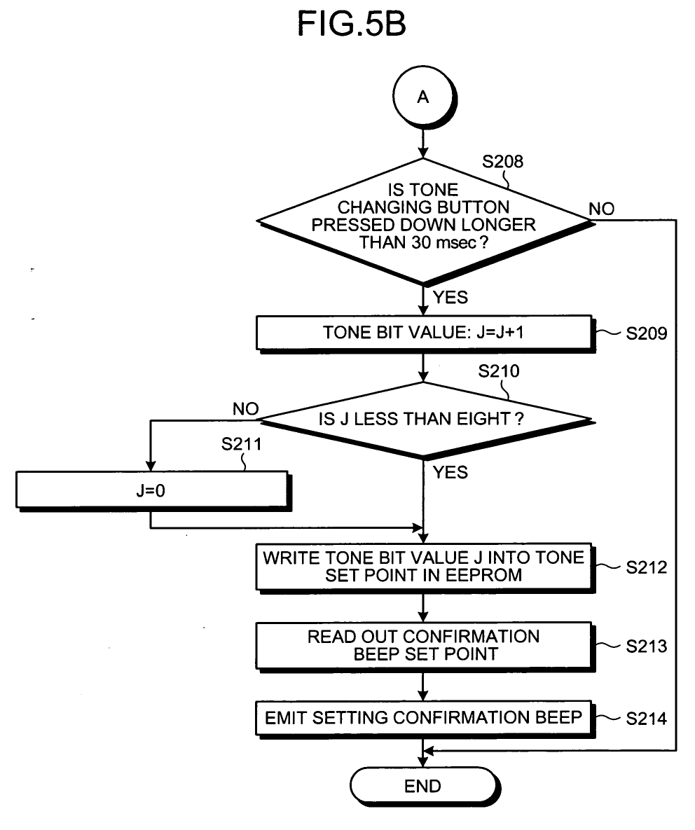

Next, a confirmation beep setting change process according to the first embodiment is explained below. FIGS. 5A and 5B is a flowchart of the confirmation beep setting change process. The confirmation beep setting change process is repeatedly executed with a certain interval during operation of the barcode reader 100.

As shown in FIG. 5A, in the confirmation beep setting change process, processing related to a volume setting change is executed first. Precisely, the CPU 160 determines whether, based on the time count done by the timing unit 180, the volume changing button 105 is pressed for a time that is longer than 30 milliseconds (step S201).

When the volume changing button 105 is pressed down for a time longer than 30 milliseconds, the CPU 160 determines that the volume changing button 105 is intentionally pressed down by an operator, and changes a volume setting. Precisely, the CPU 160 reads out a volume value from the EEPROM 150, recognizes the value as a volume bit value I, and increments the volume bit value I (step S202), and when a resultant value I becomes eight or more (step S203, NO), the value I is reset (step S204). The CPU 160 then rewrites the volume value stored the EEPROM 150 to this changed volume bit value I (step S205).

The CPU 160 then reads out a changed confirmation beep settings stored in the EEPROM 150 (step S206), transfers the changed confirmation beep settings to the controller unit 110, and makes the speaker 103 emit a confirmation beep at volume level and with a tone level corresponding to the changed confirmation beep settings as a setting confirmation beep (step S207). After this processing is finished, operation is shifted to steps S208 and afterward shown in FIG. 5B.

By contrast, when the volume changing button 105 is not pressed down at all, or when the volume changing button 105 is not pressed down for a time longer than 30 milliseconds, operation goes to step S208 shown in FIG. 5B, to shift to processing related to a tone setting without changing volume setting.

The CPU 160 then executes processing related to a tone setting change. Precisely, the CPU 160 determines whether, based on the time count done by the timing unit 180, the tone changing button 106 is pressed for a time that is longer than 30 milliseconds (step S201).

When the tone changing button 106 is pressed down for a time longer than 30 milliseconds, the CPU 160 determines that the tone changing button 106 is intentionally pressed down by an operator, and changes a tone setting. Precisely, the CPU 160 reads out a tone value from the EEPROM 150, recognizes the value as a tone bit value J, and increments the tone bit value J (step S209), and when a resultant value J becomes eight or more (step S210, NO), the value J is reset (step S211). The CPU 160 rewrites the tone value stored the EEPROM 150 to this changed tone bit value J (step S212).

The CPU 160 then reads out a changed confirmation beep settings stored in the EEPROM 150 (step S213), transfers the changed confirmation beep settings to the controller unit 110, makes the speaker 103 emit a confirmation beep at a volume level and with a tone level corresponding to the changed confirmation beep settings as a setting confirmation beep (step S214), and terminates the confirmation beep setting change process.

By contrast, when the tone changing button 106 is not pressed down at all, or when the tone changing button 106 is not pressed down for a time longer than 30 milliseconds, the confirmation beep setting change process is terminated without changing tone setting.

In the barcode reader 100, the volume changing button 105 and the tone changing button 106 are provided separately; when the volume changing button 105 is pressed down, a setting confirmation beep at changed volume is emitted from the speaker 103; while the tone changing button 106 is pressed down, a setting confirmation beep with a changed tone is emitted from the speaker 103; so that a confirmation beep can be adjusted by confirming a changed setting, and this allows an operator to obtain a confirmation beep at an own desired level quickly.

In the first embodiment, a confirmation beep emitted from the speaker 103 on the barcode reader 100 is made at a single frequency. However, a confirmation beep is not limited to a single frequency, it can also be configured to make two sounds at different frequencies continuously. In a variant, a case where two sounds at different frequencies are continuously made is explained.

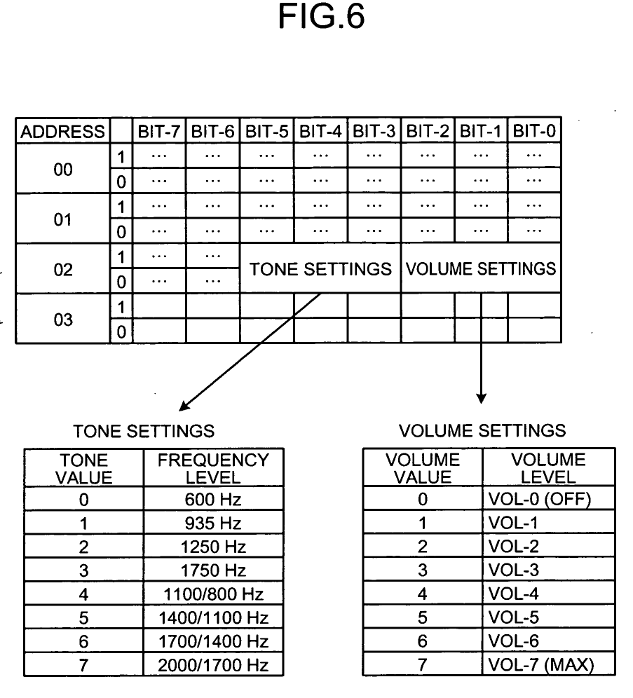

FIG. 6 is a schematic for explaining a correspondence between confirmation beep settings and confirmation beep setting lists according to the variant of the first embodiment. A format of a confirmation beep settings stored in the EEPROM 150 shown in top table, and volume values and tone values in confirmation beep setting lists kept by the controller unit 110 shown in bottom table are similar to those in the first embodiment, therefore detailed explanation is omitted.

For an expedient purpose of simplified explanation below, a case where a beep is made at a single frequency is referred to as “the monotone mode”, while a case where two sounds at different frequencies are continuously made is referred to as “the multitone mode”.

As shown in the bottom table, the controller unit 110 holds eight frequencies, in which four tone values from 0 to 3 correspond to single frequencies, and the rest of the four tone values from 4 to 7 correspond to two different frequencies each. Precisely, when a tone value is between 0 and 3, the monotone mode is selected, while when a tone value is between 4 and 7, the multitone mode is selected.

When the multitone mode is selected, a beeping time period to emit a confirmation beep from the speaker 103 is halved to emit two sounds continuously at different frequencies, by differentiating the frequencies between the first half and the second half. For example, assuming that the tone value is 4, a beep is made from the speaker 103 at 1100 Hz in the first half, and at 800 Hz in the second half of a beeping time period.

When the tone changing button 106 is pressed down, the CPU 160 replaces a tone value in the confirmation beep settings stored in the EEPROM 150. In this operation, the tone value changes in order of 0, 1, 2, 3, . . . , 7 as the tone changing button 106 is pressed down each time, an output frequency is changed within the monotone mode.

If the tone changing button 106 is pressed down when a tone value is 3, the tone value is changed to 4, and the monotone mode shifts to the multitone mode. Subsequently each time when the tone changing button 106 is pressed down, the tone value changes in order of 4, 5, 6, and 7, and an output frequency is changed within the multitone mode.

If the tone changing button 106 is pressed down when a tone value is 7, the tone value is reset to 0, and returns to the monotone mode again. Thus, when the tone changing button 106 is pressed down every four times, between the monotone mode and the multitone mode are switched back and forth.

Furthermore, when the tone changing button 106 is pressed down and a tone setting is changed, the CPU 160 makes the speaker 103 emit a beep sound with a changed tone via the controller unit 110 at once.

Thus, configuration provided with the monotone mode and the multitone mode enables selection of a confirmation beep from the two modes with the tone changing button 106 so that variation of selectable tones can be extended.

In the variant of the first embodiment, the barcode reader 100 is provided with the monotone mode and the multitone mode, however, when an operator desires to switch between the monotone mode and the multitone mode, the operator needs to press down the tone changing button 106 up to four times, which can be inconvenient in some circumstances. In a second embodiment of the present invention, a case where the monotone mode and the multitone mode can be switched with button operation once is explained. Hardware configuration of the barcode reader 100 according to the second embodiment is similar to the one according to the first embodiment, therefore detailed explanation is omitted.

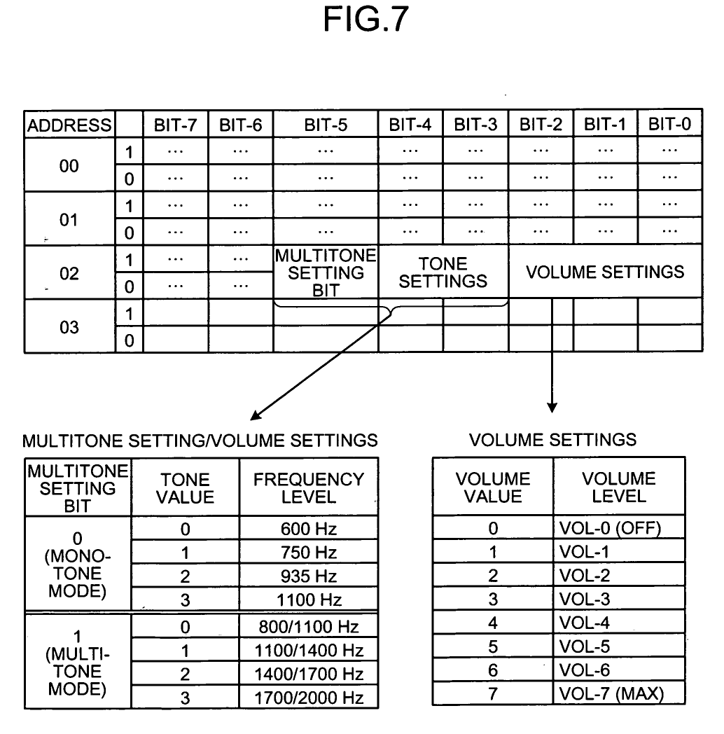

FIG. 7 is a schematic for explaining a correspondence between confirmation beep settings and confirmation beep setting lists according to the second embodiment. Top table in FIG. 7 is a format of confirmation beep settings stored in the EEPROM 150. The highest bit in the confirmation beep settings stored in the EEPROM 150 are allocated to a multitone setting bit value, and multitone setting bit value 0 indicates the monotone mode, while 1 indicates the multitone mode. Two bits are allocated to a tone value and three bits are allocated to a volume value.

In the second embodiment, the monotone mode and the multitone mode are switched by pressing down the volume changing button 105 and the tone changing button 106 simultaneously. Precisely, when the volume changing button 105 and the tone changing button 106 are simultaneously pressed down, the CPU 160 inverts a multitone setting bit value in the EEPROM 150.

As a result, when the monotone mode is selected, the multitone setting bit value is changed from 0 to 1 to shift to the multitone mode. When the multitone mode is selected, the multitone setting bit value is changed from 1 to 0 to shift to the monotone mode. Thus, the monotone mode and the multitone mode can be switched.

The volume changing button 105 and the tone changing button 106 are, as shown in FIG. 1, arranged next to each other so that an operator can press down the two buttons 105 and 106 simultaneously. Thus, the operator can easily switch between the monotone mode and the multitone mode without disturbing checkout operation.

Because between the monotone mode and the multitone mode are switched by pressing down the volume changing button 105 and the tone changing button 106 simultaneously, the monotone mode and the multitone mode can be switched only with the two buttons 105 and 106, and no additional button switching between the monotone mode and the multitone mode needs to be provided on the reading surface 101 of the barcode reader 100.

Bottom table in FIG. 7 is confirmation beep setting lists owned by the controller unit 110. As shown in the bottom table, the controller unit 110 keeps four frequencies each separately in the monotone mode and the multitone mode corresponding to tone values. The output frequency levels are similar to those in the variant of the first embodiment shown in FIG. 6, however, in the second embodiment, when only the tone changing button 106 is pressed down, the monotone mode and the multitone mode are not switched, and a frequency is changed within the monotone mode or within the multitone mode.

Precisely, when the tone changing button 106 is pressed down each time, the CPU 160 changes a tone value in the confirmation beep settings stored in the EEPROM 150 in order of 0, 1, 2, and 3; and then, because the tone values are four types, if the tone changing button 106 is pressed down when the tone value is 3, the tone value is reset to 0.

To make the speaker 103 emit a confirmation beep, the CPU 160 reads out a confirmation beep settings stored in the EEPROM 150, and transfers the read value to the controller unit 110. Based on a volume value, a tone value, and a multitone setting bit value in the confirmation beep settings, the controller unit 110 then makes the speaker 103 emit a confirmation beep at an output volume level corresponding to the volume value and at an output frequency corresponding to the tone level in a mode indicated by the multitone setting bit value.

When the volume changing button 105 and the tone changing button 106 are simultaneously pressed down and the monotone mode and the multitone mode are switched, the CPU 160 makes the speaker 103 emit a beep sound in a changed mode via the controller unit 110 at once. This allows an operator to confirm which of the monotone mode and the multitone mode is applied as soon as the setting is changed.

In processing operations in a barcode reading process by the barcode reader 100 according to the second embodiment, a difference from the first embodiment is only that the CPU 160 reads out a multitone setting bit value, in addition to a volume value and a tone value, as the confirmation beep settings to be read out in step S105 shown in FIG. 4, therefore detailed explanation is omitted.

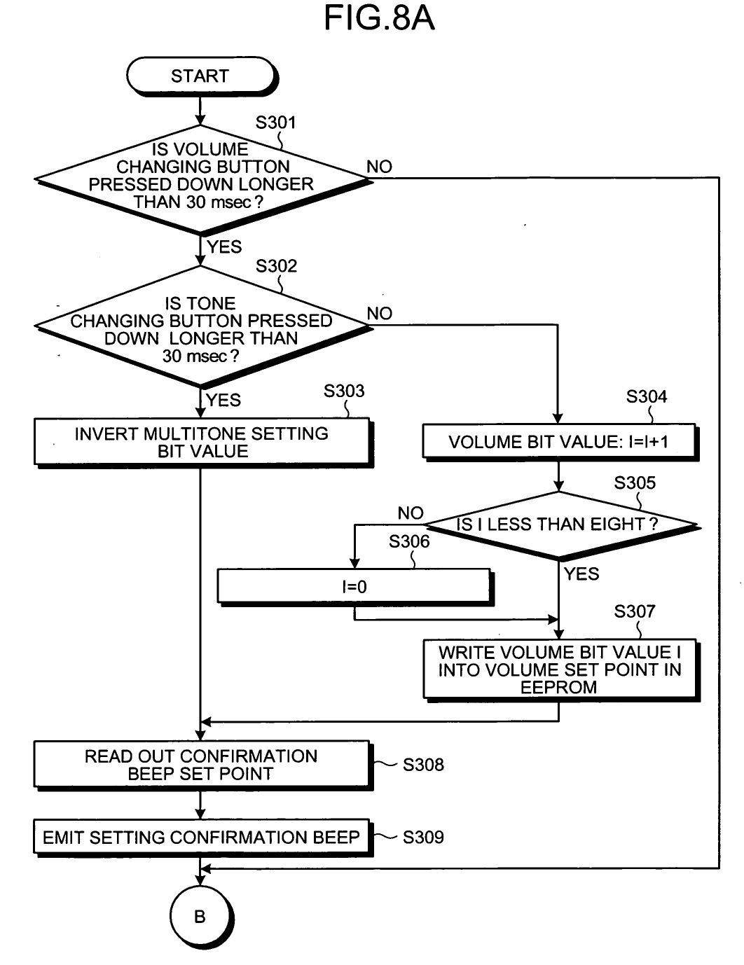

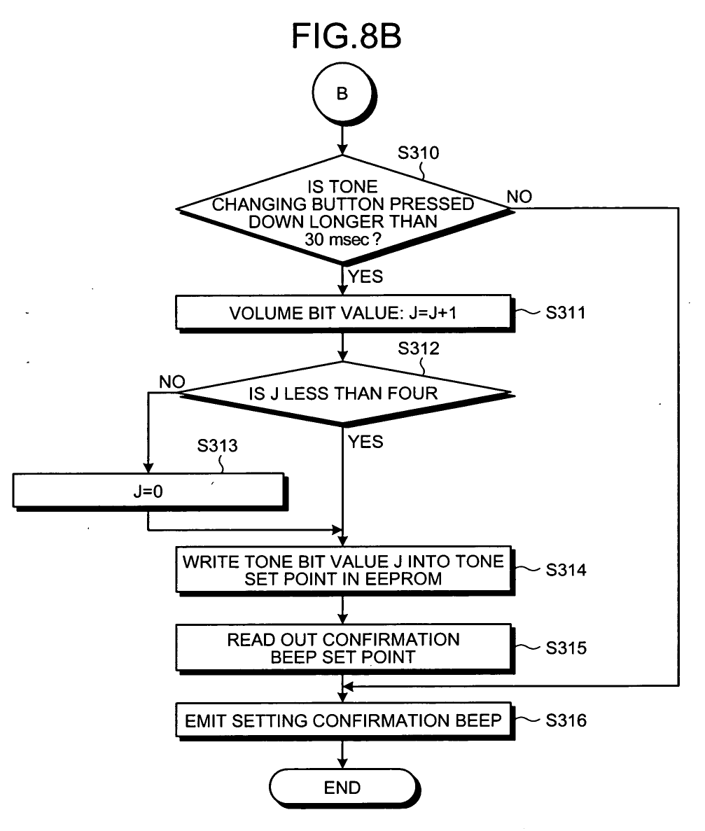

Next, a confirmation beep setting change process according to the second embodiment is explained below. FIGS. 8A and 8B is a flowchart of the confirmation beep setting change process. As shown in FIG. 8A, in the confirmation beep setting change process, the CPU 160 determines whether, based on the time count done by the timing unit 180, the volume changing button 105 is pressed for a time that is longer than 30 milliseconds (step S301).

When the volume changing button 105 is pressed down for a time longer than 30 milliseconds, the CPU 160 also determines whether, based on the time count done by the timing unit 180, the tone changing button 106 is pressed for a time that is longer than 30 milliseconds (step S302).

When the tone changing button 106 is pressed down for a time longer than 30 milliseconds, the CPU 160 determines that the volume changing button 105 and the tone changing button 106 are simultaneously pressed down, and inverts a multitone setting bit value in the confirmation beep settings in the EEPROM 150 (step S303). This results in switching between the monotone mode and the multitone mode.

By contrast, when the tone changing button 106 is not pressed down at all, or when the tone changing button 106 is not pressed down for a time longer than 30 milliseconds, the CPU 160 determines that only the volume changing button 105 is pressed down, and changes a volume setting. Precisely, the CPU 160 reads out a volume value from the EEPROM 150, recognizes the value as a volume bit value I, and increments the volume bit value I (step S304), and when the resultant value I becomes 8 or more (step S305, NO), the value I is reset (step S306). The CPU 160 then rewrites the volume value stored the EEPROM 150 to this changed volume bit value I (step S307).

The CPU 160 then reads out a changed confirmation beep settings stored in the EEPROM 150 (step S308), transfers the changed confirmation beep settings to the controller unit 110, and makes the speaker 103 emit a confirmation beep at a volume level with a tone level in a beeping mode corresponding to the changed confirmation beep settings as a setting confirmation beep (step S309). After this processing is finished, operation is shifted to steps S310 and afterward shown in FIG. 8B.

By contrast, when the volume changing button 105 is not pressed down at all, or when the volume changing button 105 is not pressed down for a time longer than 30 milliseconds, operation goes to step S310 shown in FIG. 8B, to shift to processing related to a tone setting without changing volume setting.

The CPU 160 then executes processing related to a tone setting change. Precisely, the CPU 160 determines whether, based on the time count done by the timing unit 180, the tone changing button 106 is pressed for a time that is longer than 30 milliseconds (step S310).

When the tone changing button 106 is pressed down for a time longer than 30 milliseconds, the CPU 160 changes a tone setting. Precisely, the CPU 160 reads out a tone value from the EEPROM 150, recognizes the read value as a tone bit value J, and increments the tone bit value J (step S311), and when a resultant value J becomes 4 or more (step S312, NO), the value J is reset (step S313). The CPU 160 then rewrites the tone value stored the EEPROM 150 to this changed tone bit value J (step S314).

The CPU 160 then reads out a changed confirmation beep settings stored in the EEPROM 150 (step S315), transfers the changed confirmation beep settings to the controller unit 110, makes the speaker 103 emit a confirmation beep at a volume level with a tone level in a beeping mode corresponding to the changed confirmation beep settings as a setting confirmation beep (step S316), and terminates the confirmation beep setting change process.

By contrast, when the tone changing button 106 is not pressed down all, or when the tone changing button 106 is not pressed down for a time longer than 30 milliseconds, the confirmation beep setting change process is terminated without changing tone setting.

Thus, the monotone mode and the multitone mode are switched when the volume changing button 105 and the tone changing button 106 are simultaneously pressed down, so that the monotone mode and the multitone mode can be switched easily, as well as atone setting can be adjusted more quickly.

In addition, in the variant of the first embodiment and in the second embodiment, a case where two sounds at different frequencies are continuously made is explained as the multitone mode, however, the present invention is not limited to this, and can be applied to other cases, such as a case where three or more sounds are continuously made, or a case where a chord is made by making sounds simultaneously at a plurality of frequencies.

According to the embodiments, a barcode reader is provide with a unit that changes a volume value for volume level by receiving a request to change volume of a confirmation beep from an operator, and makes a beep sound at a volume level corresponding to the changed volume value; and with a unit that is controllable separately from the former unit, changes a tone value for tones by receiving a request to change a tone of a confirmation beep from an operator, and makes a beep sound with a tone level corresponding to the changed tone value; thereby a confirmation beep can be adjusted with confirming a changed setting so that the operator can quickly obtain a confirmation beep at the own desired level.

Moreover, the barcode reader is configured to change a volume setting and/or a tone setting with button(s), and an operator can change volume and/or a tone of a confirmation beep only by pressing down button(s), so that convenience of operation can be improved.

Furthermore, the barcode reader includes a monotone mode that a beep is made at a single frequency, and a multitone mode that beep sounds at a plurality of different frequencies are continuously made; and it is configured to switch between the monotone mode and the multitone mode according to a tone value, so that variations of selectable tones can be extended.

Moreover, the barcode reader includes the monotone mode that a beep is made at a single frequency, and the multitone mode that beep sounds at a plurality of different frequencies are continuously made; and it is configured that when a request to switch between the monotone mode and the multitone mode is received from an operator, the monotone mode and the multitone mode are switched, and when a tone value is changed, a tone of a confirmation beep is changed without switching between the monotone mode and the multitone mode, so that the monotone mode and the multitone mode can be switched easily, as well as a tone setting can be adjusted more quickly.

Furthermore, the barcode reader is configured to accept a switching request when an operation of changing a volume setting and an operation of changing a tone setting are simultaneous, so that the monotone mode and the multitone mode can be switched only with the two buttons without another button provided separately for switching between the monotone mode and the multitone mode.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A barcode reader that outputs a notifying sound upon successfully reading a barcode, comprising:
a volume changing unit operable by a user to change a volume value indicative of an output volume level of the notifying sound;
a volume setting changing unit that changes an output volume level of the notifying sound based on the volume value;
a tone changing unit operable by the user to change a tone value indicative of an output tone level of the notifying sound;
a tone setting changing unit that changes an output tone level of the notifying sound based on the tone value; and
a beeping unit that outputs notifying sound at the volume level and the tone level.

2. The barcode reader according to claim 1, wherein the volume changing unit and the tone changing unit are in a form of buttons.

3. The barcode reader according to claim 2, wherein the buttons are provided on a side of the barcode reader from which the barcode reader emits light on the barcode.

4. The barcode reader according to claim 3, wherein a plurality of symbols indicative of values are provided on the side near the buttons.

5. The barcode reader according to claim 1, wherein the tone level corresponds to frequency of the notifying sound.

6. The barcode reader according to claim 1, wherein the beeping unit is configured to make a monotone sound at a single frequency and a multitone sound at a plurality of different frequencies, and
whether a monotone sound or a multitone sound is to be output as the notifying sound is decided based on the tone value set in the tone changing unit.

7. The barcode reader according to claim 1, wherein the beeping unit is configured to make a monotone sound at a single frequency and a multitone sound at a plurality of different frequencies, and the barcode reader further comprising a monotone-multitone changing unit operable by the user to change whether a monotone sound or a multitone sound is to be output as the notifying sound, and
when a tone value is changed by operating the tone changing unit, only a tone level of the notifying sound is changed.

8. The barcode reader according to claim 1, wherein the beeping unit is configured to make a monotone sound at a single frequency and a chord sound at a chord with a plurality of different frequencies, and the barcode reader further comprising a monotone-chord changing unit operable by the user to change whether a monotone sound or a chord sound is to be output as the notifying sound, and
when a tone value is changed by operating the tone changing unit, only a tone level of the notifying sound is changed.

9. The barcode reader according to claim 7, wherein the monotone-chord changing unit includes the volume changing unit and the tone changing unit.

10. The barcode reader according to claim 8, wherein the monotone-chord changing unit includes the volume changing unit and the tone changing unit.

11. The barcode reader according to claim 3, wherein the buttons are provided such that the buttons can be operated simultaneously with two fingers of a hand of the user.
